(19) United States
(12) Patent Application Publication
(10) Pub. No.: US 2015/0194179 A1
(43) Pub. Date: Jul. 9, 2015

(54) HANDS-FREE MEDIA DEVICE CONTROL APPARATUS

(71) Applicant: David Wayne SMITH, Fallbrook, CA (US)

(72) Inventor: David Wayne SMITH, Fallbrook, CA (US)

(21) Appl. No.: 14/589,368

(22) Filed: Jan. 5, 2015

Related U.S. Application Data
(60) Provisional application No. 61/964,369, filed on Jan. 3, 2014.

(51) Int. Cl. G11B 15/02; H04N 5/44; H04W 4/00

(52) U.S. Cl. CPC G11B 15/023; H04W 4/008; H04N 5/4403; H04N 2005/4426

(57) ABSTRACT

A method of manipulating content on a media device with a hands-free device including selecting content to play on the media device and then operatively connecting the hands-free device to the media device. The hands-free device has a case with upper, lower, and one or more intermediate portions, one or more hands-free switches disposed on or in the case, each switch being operable to transmit one or more commands to manipulate the content of or accessible by the media device. The device also has a controller for managing information transmitted between the switches and the media device and a data link formed between the controller and the media device. Once operatively connected, the selected content accessible by the mediate device is manipulated by controlling the one or more hands-free switches of the hands-free device.

### RELATED APPLICATION

The present disclosure claims priority to U.S. Provisional Patent Application 61/964,369, entitled, HANDS-FREE, FOOT OPERATED COMPUTER VIDEO CONTROL, filed Jan. 3, 2014, the full disclosure of which is incorporated herein by reference in its entirety.

### FIELD

The present disclosure relates generally to devices and systems in the consumer electronics field directed toward instruction and education through the use of media devices that playback, for example, audiovisual content.

### BACKGROUND

Since the advent of personal computing, media devices such as personal computers, personal readers, planners, and tablets has been a tremendous instructional aid when communicating, training, or otherwise learning any number of skills or concepts. In recent years, this modern instructional aid has left the office place and is now used in alternative settings such as the garage, the kitchen, parks, the classroom, or the like where access to the media device itself may be limited.

Therefore, there exists a need to provide a device that does not require hands when managing and/or manipulating content on a media device so that learning, performance or instruction may continue uninterrupted since both hands can remain with a particular apparatus, tool, controller, instrument or the like, away from the media device.

### SUMMARY

The following simplified summary is provided in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In a preferred embodiment, a hands-free device for controlling and manipulating content on a media device comprises a case, one or more hand-free switches, a controller, and a data link. The case may have upper, lower, and one or more intermediate portions. Each switch may be disposed on, within, partially within, upon or otherwise positioned with respect to the case so that it remains operable to transmit one or more commands received by a user to manipulate the content accessible by the media device. The controller is operable to manage information transmitted between the switches and the media device. The data link is formed between the controller and the media device and may be a direct connection through a cable or may be an indirect connection through a wireless connection (e.g. radio waves, through local or remote networks, etc.).

In those embodiments where the data link is an indirect connection, the data link may utilize a Bluetooth communication protocol or the data link may be formed through one or more local or remote network servers. The case may be shaped in a rectangular, triangular, circular, cylindrical, elliptical, or a polynomial manner with a plurality of edges. In this respect, the case may be bored out, hollow, molded, or constructed from a plurality of attached elements one or more of which may optionally be removable. Optionally, the upper portion of the case is shaped to receive a foot, or another appendage, of a user.

In some embodiments, the one or more hands-free switches may be disposed on the upper or intermediate portions of the case. In a preferred embodiment, the device has at least three hands-free switches. A first switch includes a function to rewind content accessible by the media device. The second switch includes a function to pause and/or play content accessible by the media device. The third switch includes a function to fast-forward content accessible by the media device. Optionally, each function associated with each switch may be customizable. Furthermore, each switch may include functionality to manipulate playback speed of the content, volume of the content, resolution of the content, quality, or to skip the content forward or rewind the content a predetermined period of time (e.g. skip forward or rewind backwards, 30 s or one minute).

The media device may be a personal computer, a tablet, a mobile device, a television, a gaming console, a personal reader, or the like. Likewise, the content of the herein disclosed devices and methods comprises audio, visual, or audiovisual elements. The content may be locally stored on the media device or may be remotely accessible by the media device.

In other embodiments, a method is disclosed for manipulating content on a media device with a hands-free device including selecting content to play on the media device and then operatively connecting the hands-free device to the media device. The hands-free device has a case with upper, lower, and one or more intermediate portions, one or more hands-free switches disposed on or in the case, each switch being operable to transmit one or more commands to manipulate the content of or accessible by the media device. The device also has a controller for managing information transmitted between the switches and the media device and a data link formed between the controller and the media device. Once operatively connected, the selected content accessible by the mediate device is manipulated by controlling the one or more hands-free switches of the hands-free device.

The method may further comprise: customizing each function associated with any one of the hands-free switches, each function comprising manipulation of playback speed of the content, volume of the content, resolution of the content, skipping the content forward or rewinding the content backwards a predetermined period of time.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a forward perspective view of an exemplary embodiment of the herein disclosed media device hands-free control apparatus, wherein the disclosed apparatus is depicted in communication with a media device.

### DETAILED DESCRIPTION

The features of the presently disclosed foot-controlled device may be economically molded by using one or more distinct parts and associated components which, when assembled together for removable application with a conventional media device, or integrally formed with the media device, in an economical fashion, wherein the features of the present disclosure may form the herein disclosed apparatus regardless of the particular form. Unless defined otherwise, all terms of art, notations and other scientific terms or terminology used herein have the same meaning as is commonly understood by one of ordinary skill in the art to which this disclosure belongs.

In some cases, terms with commonly understood meanings are defined herein for clarity and/or for ready reference, and the inclusion of such definitions herein should not necessarily be construed to represent a substantial difference over what is generally understood in the art. All patents, applications, published applications and other publications referred to herein are incorporated by reference in their entirety. If a definition set forth in this section is contrary to or otherwise inconsistent with a definition set forth in the patents, application, published applications and other publications that are herein incorporated by reference, the definition set forth in this section prevails over the definition that is incorporated herein by reference.

As used herein, “a” or “an” means “at least one” or “one or more.” As used herein, the term “user”, “subject”, “end-user” or the like is not limited to a specific entity or person. For example, the term “user” may refer to a person who uses the systems and methods described herein, and frequently may be a field technician. However, this term is not limited to end users or technicians and thus encompasses a variety of persons who can use the disclosed systems and methods.

“Media device” is understood as any one of, or combination of, personal computers, such as a PC or a Mac, tablets, mobile devices, smart phones, personal readers, gaming consoles, televisions, projectors, screens, or the like.

“Content” is understood as any type of content reproducible, accessible, or otherwise readable or playable by a media device such as audio content such as songs, podcasts, or instructional recordings. Content also includes visual content such as presentations, pdfs, word documents, e-books or other word-readable documents, recordings, presentations, PowerPoint material, movies, videos including instructional videos, pictures, diagrams, graphics, or other printed content such as diagrams, lesson plans, sheet music, or the like. Content may include only audio elements, only visual elements, or audio and visual portions.

“Hands-free” when used with the herein described functions and switches is intended to mean manipulated by or otherwise controlled by limbs or portions of a user other than the hands. Preferably, “hands-free” is intended to mean switches or functionality that is operable by a foot or feet of a user but the herein disclosed apparatus is not so limited. “Hands-free”, however, may include any portion of a body such as nose, an ear, forehead, knee, leg, or the like (including attachments thereto or extensions thereof) in such a manner so that the user's hands may be free to continue engaging the particular apparatus or instrument while still managing or otherwise manipulating content of a media device.

For example, the budding home mechanic may not know how to perform a particular repair on his car. In this scenario, he may perform a search and access certain audiovisual content such as an instructional video on YouTube®. A simple click of the mouse and the budding mechanic can begin learning how to perform the desired repair. However, once under the hood of the automobile, the budding mechanic may wish to pause the content, replay the content, rewind, etc. which is difficult given his location under the hood with his hands tied up with the repair. In fact, his hands may be dirty, or occupied by a tool, such that the budding mechanic may not be capable of freeing his hands without altogether stopping the operation, removing himself from underneath the automobile and physically accessing the media device. This in turn unnecessarily risks harm to the media device (e.g. dirty hands on the media device) and is a considerable waste of time resources (e.g. constant start/stopping each activity by moving from underneath the hood and in front of the media device) as well as mental resources (e.g. continual starting/stopping of potentially complex ideas by having to clean one's hands and physically move one's self from tight locations to the media device).

Similarly, a user may be interested in learning how to play the guitar by consulting instructional content through a media device. For example, the user may wish to learn how to play a particular song by accessing a video where an instructor meticulously instructs how to play each note with appropriate rhythm and hand positioning on the guitar. The user then follows along and will typically replay certain portions of the song or instruction to reinforce certain concepts or principles not learned or understood in the first pass. In current systems, manipulating this instructional video requires the user to remove her hands from the guitar and then manipulate the content accessed by the media device with her hands (e.g. pause, rewind, play). Only then can the student re-position her hands on the guitar in the desired position and continue learning or practicing the desired concept. This is particularly frustrating as hand placement on the guitar and/or speed can be complicated and of varying difficulty (extremely fast and technical to relatively slow and less technical). In this respect, identifying the specific portion where mistake was made and where the user would like to re-start is particularly frustrating with this hands-on and hands-off problem.

Finally, professional musicians typically follow along during recitals or performances with material such as sheet music. Current approaches require the musician to physically remove their hands from their instrument during the performance, adjust the sheet music to a desired page or position, and then return their hands to their instrument so the performance can continue. This interrupts the musician and thus interrupts the performance.

The disclosed device and methods described herein resolve these problems by easily and securely controlling, driving, manipulating or otherwise managing content accessed by a media device. The herein disclosed apparatus may access one or more different sized or types of media devices vehicles through a single direct data link (e.g. USB cord between respective USB ports), multiple direct links, direct and indirect (e.g. wireless data links), and thus a single point of control. The herein described approach is easy to manufacture and can be adapted to currently known media devices thereby reducing the ultimate cost for the operator (e.g. field technician or vehicle owners interesting in carrying out home repair) and the need to purchase special media devices for each given application. Said herein disclosed apparatus and corresponding system and method can now be better understood turning to the following detailed description. It is to be expressly understood that the illustrated embodiments are set forth as examples and not by way of limitations on the embodiments as ultimately defined in the claims.

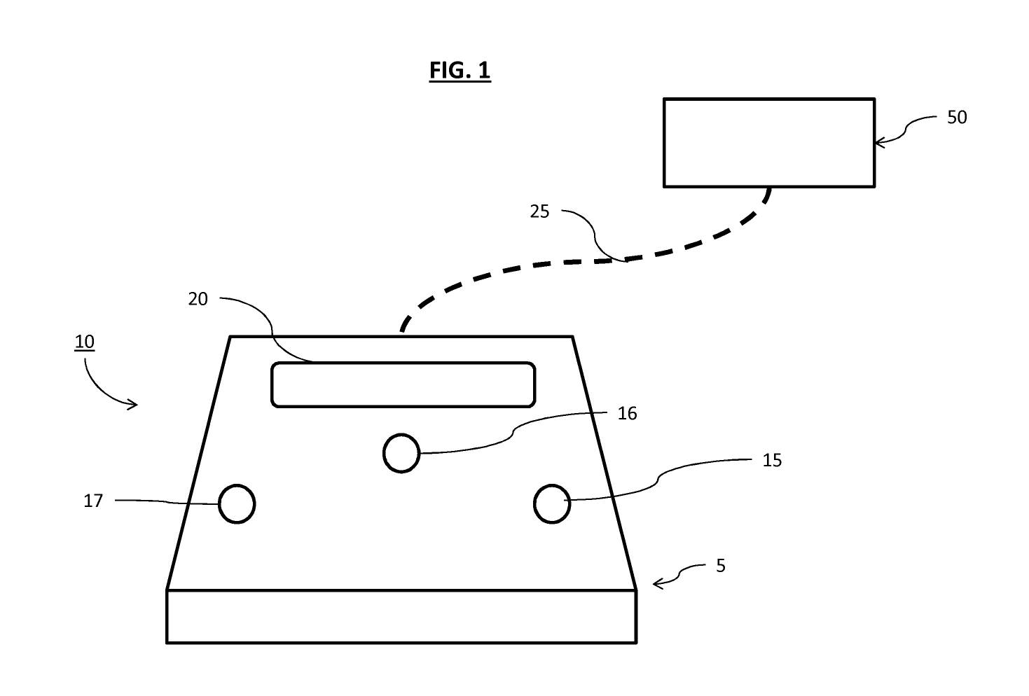

Turning to the drawings, FIG. 1 depicts a hands-free media device control apparatus 10 comprising a case 5. Case 5 is seen in a generally three-dimensional rectangular cross section though the herein disclosed apparatus 10 is not so limited. In other embodiments, case 5 may take any form that according to design need or preference including cylindrical, triangular, or a polynomial with any number of sides. Case 5 may be solid, hollow, bored out, or some combination thereof. Likewise, case 5 may be molded or may be constructed from a plurality of constituent parts (e.g. perimetral side portions that removably attach to an upper portion and/or a base portion). Optionally, case 5 or at least the upper portion of case 5 may be shaped to receive a user's foot and may therefore comprise of a soft, yet resilient surface to both comfortably receive a foot and sustain the force of a user's foot.

Apparatus 10 is also depicted in communication with a media device 50, either directly or indirectly, through data link 25. Accordingly, device 50 and apparatus 10 may directly connect through a data link 25 such as a cable (e.g. standard Universal Serial Bus cable, fire wire cable, etc) or indirectly through Bluetooth®, other wireless device-to-device wireless communication protocols, or even through local and/or remote networks.

Device 10 may locally comprise, or be capable of remotely accessing, one or more files that are desirous to be played by a user such as audio, visual, or audiovisual content as previously described. In this respect, apparatus 10 also comprises one or more switches 15, 16, 17 which are depicted on the upper portion of the case 5. When apparatus 10 is positioned prior to use, for example, on the ground, a user may operatively connect apparatus 10 to device 50 through data link 25 and utilize switches 15, 16, and 17 to manipulate content being accessed by or otherwise played by media device 50.

The position and number of switches 15, 16, 17 of FIG. 1 are not so limited as each switch may be positioned in accordance with design need or preference. For instance, a user may desire to have fewer or a greater number of switches in operation with apparatus 10. Each switch may likewise be integrally formed with case 5 or removably attached and/or positionable at multiple locations depending on need or preference. For example, a user may be desirous of transmitting commands through switches 15, 16, 17 when they are positioned on the lateral side portion of case 10 as opposed the upper portion. Likewise, a user may find it desirous to add or remove switches depending on need or preference for added control and individualized experience.

Apparatus 10 may also comprise a controller in communication with switches 15, 16, and 17, and data link 25 in order control information transmission between apparatus 10 and device 50. In a preferred embodiment, direct link 25 between device 50 and the herein disclosed apparatus 10 may be a Universal Serial Bus (USB) cable and the controller may be a USB microcontroller. However, the design is not so limited such that in other embodiments, data link 25 between the media device and the herein disclosed apparatus 10 may be formed from any number of previously known cables such as coaxial, mini and micro USB, FireWire, Ethernet, MIDI, eSATA, Thunderbolt, or the like as well as any to-be-designed cables operable to transfer information between the herein disclosed apparatus 10 and media device 50.

In other embodiments, the herein disclosed apparatus 10 may operatively connect to the media device 50 through an indirect data link 25 such as a local network, a remote network, or through radio waves such as Bluetooth® communication protocol or any to-be-designed wireless device-to-device wireless communication protocols including apps installable on media device 50 to provide an indirect data link 25 between device 50 and apparatus 10.

In some embodiments, apparatus 10 may comprise one or more switches 20 to activate the device 10 between an operational and non-operational state. The one or more switches 20 may likewise be configured to activate data link 25 so that an operative communication bridge is formed between device 50 and apparatus 10. The one or more switches 15, 16, 17, 20 (as well as any other switches not depicted in FIG. 1 but within the principle of this application) may also be configured to issue commands to the media device 50, the one or more switches may be generally arranged in a linear array, a non-linear array across the top, the bottom, the sides of case 5, or any other location according to design need or preference. In certain embodiments, the switches are arranged to correspond to a natural range of movement of the appendage intended to be utilized to manipulate the switches. For example, in the case of a foot, in certain embodiments, the switches are arranged in a semi-circular arc corresponding to the rotation of a foot around an axis located at the user's heel or portion thereof.

Preferably, the one or more switches may be positioned such that each switch can be easily accessed for control by one or more parts of a user that are not hands such as a foot, any other limb, or portion thereof. Optionally, the settings, location, and/or functions of each switch may be established during assembly of the herein disclosed apparatus 10. The settings, location, and/or functions may altered by the end-user so that each performance may be customized for a given application or individual need. For example, a user following a cooking lesson may utilize different settings such as functions (pause, play, fast forward, replay, etc.) than a musician using the herein disclosed apparatus 10 during a musical performance where the user may need to flip one or more pages of sheet music reproducible on media device 50 (i.e. next page or next song) without removing their hands from their instrument.

In those embodiments where the herein disclosed apparatus 10 operatively connects to the media device 50 through a direct USB link 25, the specific functions may be described as follows:
i. A first perimetral switch 17 positioned on the left portion of the herein disclosed apparatus 10 may be configured to the “left arrow” keyboard function of a conventional keyboard;
ii. A first center switch 16 positioned in the center portion of the herein disclosed apparatus 10 may be configured to the “space bar” keyboard function of a conventional keyboard; and/or
iii. A second perimetral switch 15 positioned in the right portion of the herein disclosed apparatus 10 may be configured to the “right arrow” keyboard function of a conventional keyboard.

During use, when the first perimetral switch 17 is depressed, the first perimetral switch 17 may cause the content currently being accessed by the media device 50 to “rewind” until the switch 17 is released. Similarly, when the second perimetral switch 15 is depressed, this will cause the content currently being accessed by the media device 50 to “fast forward” until the switch 15 is released. Finally, when the first center switch 16 is depressed, this may cause the content being accessed by the media device to toggle between “play” and “pause”. In other embodiments, however, switches 15, 16, 17 or any other switches may instead be capacitive sensors, springs, latches, or any other type of buttons operative to receive input from an end-user and communicate said input through the controller, data link 25 and ultimately device 50.

In other embodiments, the one or more switches may include a function that allows the user to drop markers along a given timeline of content being accessed by the media device 50 in order to create a user-defined loop or optionally to navigate with little effort between user-defined positions in the audio and/or video content. For example, positions at times 3:30, 4:30, and 7:00 may relate to relevant or noteworthy portions of an instructional video to the extent the end-user may find it desirous to locate and drop a time marker in each one of these positions so that during use the end-user user can navigate between each position. Likewise, the end-user may also use the herein disclosed apparatus 10 and associated switches to identify a customizable length of the audio and/or video of the accessed content that may be desirous to play one or more times or repeatedly until stopped by the end-user (e.g. a particular portion of an instructional video).

In other embodiments, the one or more switches may also be operable to manipulate certain settings of the content including playback speed, volume, resolution or quality at which the content is played, a complete replay of the selected content, a command to skip ahead or rewind a predetermined interval of time including 5 seconds, 10 seconds, 30 seconds or the like. The interval of time may be customized by a user depending on design need or preference. Optionally, the one or more switches may be configured so that one or more externally connected playback devices (e.g. devices such as screens or speakers other than device 50) may likewise be operatively coupled to the media device 50. For example, the end user may desire to switch to a larger screen, to multiple screens in the same location or in multiple locations, to multiple speakers, or the like such that activating one or more of the switches can effect such a desired modification in settings of the content then being currently accessed by the media device 50 and manipulated by apparatus 10.

In embodiments where the media device 50 is accessing content that is strictly visual such as a pdf, word documents, e-book, or other text readable electronic file formats, the one or more switches of the apparatus 10 may be configured to move forward or rewind between pages, paragraphs, chapters, songs, lessons, volumes, or entire books or files altogether.

In all embodiments, the herein disclosed apparatus 10 therefore will provide the user the ability to manipulate certain controls for media devices such as the ‘play/pause’, rewind, and ‘fast forward’ functions of any form of audio and/or visual content (hereinafter “content”), locally stored or remotely accessible, such as content that is accessible on YouTube® that is typically accessed via the internet through all types of media devices. As content is frequently used as a teaching medium, the herein disclosed apparatus 10 will assist students, teachers or other users in the learning, teaching, or performance of subjects requiring two hands to perform, learn, or otherwise play including musical instruments such as guitar, cello, violin, percussion or reed instruments.

The herein disclosed apparatus 10 is particularly advantageous when used with crafts such as knitting, needlepoint or knot tying as well as cooking and science experiments wherein both hands of the user, teacher, or the like are necessary. Accordingly, any instance or situation where a user or teacher would benefit from by being utilize a hands-free media device control apparatus 10 in order to keep both hands engaged with the desired activity or project as opposed to the otherwise unnecessary and inevitable pause or interruption.

For example, when the herein disclosed apparatus 10 is utilized to manipulate content accessible through YouTube (or another provider or site), once a particular video is selected, the user can effect one or more commands such as play/pause, fast-forward, and/or rewind for the purpose of review or looping back to any segment in the video content with the use of one's foot to drive switches of apparatus 10 and thus content being played by device 50.

Many alterations and modifications may be made by those having ordinary skill in the art without departing from the spirit and scope of the embodiments disclosed and described herein. Therefore, it is understood that the illustrated and described embodiments have been set forth only for the purposes of examples and that they are not to be taken as limiting the embodiments as defined by the following claims. For example, notwithstanding the fact that the elements of a claim are set forth below in a certain combination, it must be expressly understood that the embodiments include other combinations of fewer, more or different elements, which are disclosed above even when not initially claimed in such combinations.

The definitions of the words or elements of the following claims are, therefore, defined in this specification to not only include the combination of elements which are literally set forth. It is also contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination(s).

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what incorporates the essential idea of the embodiments.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hands-free device for controlling content on a media device, comprising:
a case with upper, lower, and one or more intermediate portions;
one or more hands-free switches disposed on or in the case, each switch operable to transmit one or more hands-free commands received by a user to manipulate the content accessible by the media device;
a controller to manage information transmitted between the switches and the media device; and
a data link formed between the controller and the media device.

2. The device according to claim 1, wherein the data link is a directly connected cable.

3. The device according to claim 1, wherein the data link is an indirect wireless connection.

4. The device according to claim 3, wherein the data link utilizes a Bluetooth communication protocol or the data link is formed through one or more local or remote network servers.

5. The device according to claim 1, wherein the case is rectangular, triangular, circular, cylindrical, elliptical, or a polynomial with a plurality of edges.

6. The device according to claim 5, wherein the case is bored out, hollow, molded, or constructed from a plurality of removably attached elements.

7. The device according to claim 5, wherein the upper portion of the case is shaped to receive a foot of a user.

8. The device according to claim 1, wherein the one or more hands-free switches are disposed on the upper or intermediate portions.

9. The device according to claim 1, the device comprising at least three hands-free switches, a first switch comprising a function to rewind content accessible by the media device, a second switch comprising a function to play or pause content accessible by the media device, and a third switch comprising a function to fast-forward content accessible by the media device.

10. The device according to claim 9, wherein each function associated with each switch is customizable.

11. The device according to claim 1, wherein the media device is a personal computer, a tablet, a mobile device, a television, a gaming console, or a personal reader.

12. The device according to claim 1, wherein the one or more switches are operable to manipulate playback speed of the content, volume of the content, resolution of the content, quality, or to skip the content forward or rewind the content a predetermined period of time.

13. A method of manipulating content accessible by a media device with a hands-free device, the method comprising:
selecting content to play on the media device;
operatively connecting the hands-free device to the media device, the hands-free device comprising:
a case;
one or more hands-free switches disposed on or in the case, each switch operable to transmit one or more commands to manipulate the content of or accessible by the media device;
a controller for managing information transmitted between the switches and the media device; and
a data link formed between the controller and the media device; and
manipulating the content selected to play on the media device by controlling the one or more hands-free switches of the hands-free device.

14. The method according to claim 13, wherein the content comprises audio, visual, or audiovisual elements.

15. The method according to claim 13, wherein the content is locally stored on the media device or is remotely accessible by the media device.

16. The method according to claim 13, wherein the hands-free device is directly connected through a cable or is indirectly connected through one or more wireless data links.

17. The method according to claim 13, wherein an upper portion of the case is shaped to receive a foot of a user.

18. The method according to claim 13, wherein the one or more hands-free switches are positioned on upper or intermediate portions of the case, the hands-free device comprising at least three hands-free switches, a first switch with a function to rewind content accessible by the media device, a second switch with a function to pause or play content accessible by the media device, and a third switch with a function to fast-forward content accessible by the media device.

19. The method according to claim 18, further comprising: customizing each function associated with any one of the hands-free switches, each function comprising manipulation of playback speed of the content, volume of the content, resolution of the content, skipping the content forward or rewinding the content backwards a predetermined period of time.
